(19) United States
(12) Patent Application Publication
(10) Pub. No.: US 2015/0138642 A1
(43) Pub. Date: May 21, 2015

(54) DURABLE HYBRID OMNIDIRECTIONAL STRUCTURAL COLOR PIGMENTS FOR EXTERIOR APPLICATIONS

(71) Applicant: Toyota Motor Engineering & Manufacturing North America, Inc., Erlanger, KY (US)

(72) Inventors: Debasish Banerjee, Ann Arbor, MI (US); Songtao Wu, Ann Arbor, MI (US); Khoa Vo, Ypsilanti, MI (US)

(21) Appl. No.: 14/607,933

(22) Filed: Jan. 28, 2015

Related U.S. Application Data
(63) Continuation-in-part of application No. 14/471,834, filed on Aug. 28, 2014.
Application No. 14/471,834 is a continuation-in-part of application No. 14/460,511, filed on Aug. 15, 2014.
Application No. 14/460,511 is a continuation-in-part of application No. 14/242,429, filed on Apr. 1, 2014.
Application No. 14/242,429 is a continuation-in-part of application No. 14/138,499, filed on Dec. 23, 2013.
Application No. 14/138,499 is a continuation-in-part of application No. 13/913,402, filed on Jun. 8, 2013.
Application No. 13/913,402 is a continuation-in-part of application No. 13/760,699, filed on Feb. 6, 2013.
Application No. 13/760,699 is a continuation-in-part of application No. 13/572,071, filed on Aug. 10, 2012.
Application No. 13/572,071 is a continuation-in-part of application No. 13/021,730, filed on Feb. 5, 2011.
Application No. 13/021,730 is a continuation-in-part of application No. 12/793,772, filed on Jun. 4, 2010, now Pat. No. 8,736,959.
Application No. 12/793,772 is a continuation-in-part of application No. 12/388,395, filed on Feb. 18, 2009, now Pat. No. 8,749,881.
Application No. 12/388,395 is a continuation-in-part of application No. 11/837,529, filed on Aug. 12, 2007, now Pat. No. 7,903,339.
Application No. 13/913,402 is a continuation-in-part of application No. 13/014,398, filed on Jan. 26, 2011.
Application No. 13/014,398 is a continuation-in-part of application No. 12/793,772, filed on Jun. 4, 2010, now Pat. No. 8,736,959.
Application No. 12/793,772 is a continuation-in-part of application No. 12/686,861, filed on Jan. 13, 2010, now Pat. No. 8,593,728.
Application No. 12/686,861 is a continuation-in-part of application No. 12/389,256, filed on Feb. 19, 2009, now Pat. No. 8,329,247.

(51) Int. Cl. G02B 5/28; G02B 5/22

(52) U.S. Cl. CPC G02B 5/286; G02B 5/22
USPC 359/584

(57) ABSTRACT

A hybrid omnidirectional structural color pigment. The pigment exhibits a visible color to the human eye and has a very small or non-noticeable color shift when exposed to broadband electromagnetic radiation (e.g. white light) and viewed from angles between 0 and 45° relative to the normal of an outer surface of the pigment. The pigment is in the form or a multilayer stack that has a reflective core layer and at least two high index of refraction (nₕ) layers. One of the nₕ layers can be a dry deposited nₕ dielectric layer that extends across the reflective core layer and one of the layers can be a wet deposited nₕ outer protective coating layer. An absorber layer that extends between the dry deposited nₕ dielectric layer and the wet deposited nₕ outer protective layer can also be included.

### CROSS REFERENCE TO RELATED APPLICATIONS

The instant application is a continuation-in-part (CIP) of U.S. patent application Ser. No. 14/471,834 filed on Aug. 28, 2014, which in turn is a CIP of U.S. patent application Ser. No. 14/460,511 filed on Aug. 15, 2014, which in turn is a CIP of U.S. patent application Ser. No. 14/242,429 filed on Apr. 1, 2014, which in turn is a CIP of U.S. patent application Ser. No. 14/138,499 filed on Dec. 23, 2013, which in turn is a CIP of U.S. patent application Ser. No. 13/913,402 filed on Jun. 8, 2013, which in turn is a CIP of U.S. patent application Ser. No. 13/760,699 filed on Feb. 6, 2013, which in turn is a CIP of Ser. No. 13/572,071 filed on Aug. 10, 2012, which in turn is a CIP of U.S. patent application Ser. No. 13/021,730 filed on Feb. 5, 2011, which in turn is a CIP of Ser. No. 12/793,772 filed on Jun. 4, 2010 (U.S. Pat. No. 8,736,959), which in turn is a CIP of Ser. No. 12/388,395 filed on Feb. 18, 2009 (U.S. Pat. No. 8,749,881), which in turn is a CIP of U.S. patent application Ser. No. 11/837,529 filed Aug. 12, 2007 (U.S. Pat. No. 7,903,339). U.S. patent application Ser. No. 13/913,402 filed on Jun. 8, 2013 is a CIP of Ser. No. 13/014,398 filed Jan. 26, 2011, which is a CIP of Ser. No. 12/793,772 filed Jun. 4, 2010, which is a CIP of Ser. No. 12/686,861 filed Jan. 13, 2010 (U.S. Pat. No. 8,593,728), which is a CIP of Ser. No. 12/389,256 filed Feb. 19, 2009 (U.S. Pat. No. 8,329,247), all of which are incorporated in their entirety by reference.

### FIELD OF THE INVENTION

The present invention is related to multilayer stack structures having protective coatings thereon, and in particular to hybrid multilayer stack structures that exhibit a minimum or non-noticeable color shift when exposed to broadband electromagnetic radiation and viewed from different angles with a protective coating thereon.

### BACKGROUND OF THE INVENTION

Pigments made from multilayer structures are known. In addition, pigments that exhibit or provide a high-chroma omnidirectional structural color are also known. However, such prior art pigments have required as many as 39 thin film layers in order to obtain desired color properties.

It is appreciated that cost associated with the production of thin film multilayer pigments is proportional to the number of layers required. As such, the cost associated with the production of high-chroma omnidirectional structural colors using multilayer stacks of dielectric materials can be prohibitive. Therefore, a high-chroma omnidirectional structural color that requires a minimum number of thin film layers would be desirable.

In addition to the above, it is appreciated that pigments can exhibit fading, changing of color, etc. when exposed to sunlight, and in particular to ultraviolet light. As such, a high-chroma omnidirectional structural color pigment that is weather resistant would also be desirable.

### SUMMARY OF THE INVENTION

A hybrid omnidirectional structural color pigment is provided. The pigment exhibits a visible color to the human eye and has a very small or non-noticeable color shift when exposed to broadband electromagnetic radiation (e.g. white light) and viewed from angles between 0 and 45°.

The pigment is in the form or a multilayer stack, also referred to as a multilayer thin film herein, that reflects a reflection band with a predetermined full width at half maximum (FWHM) of less than 300 nm. In addition, the reflection band has a predetermined color shift of less than 30° on an a*b* color map using the CIELAB color space when the pigment is exposed to broadband electromagnetic radiation and viewed from angles between 0 and 45°.

The multilayer stack has a reflective core layer and at least two high index of refraction (nₕ) layers. One of the nₕ layers can be a dry deposited nₕ dielectric layer that extends across the reflective core layer and one of the layers can be a dry deposited absorber layer that extends across the dry deposited nₕ dielectric layer. The multilayer stack also includes an outer protective layer which can be in the form of a wet deposited nₕ outer oxide layer. In some instances, the wet deposited nₕ outer oxide layer covers and is in direct contact with the dry deposited absorber layer and may or may not completely surround or envelope the reflector core layer and at least two nₕ layers.

The reflective core layer can be a metallic reflector core layer that has a thickness between 30-200 nm. In some instances the metallic core reflector layer is made from at least one of Al, Ag, Pt, Cr, Cu, Zn, Au, Sn and alloys thereof.

The dry deposited nₕ dielectric layer is made from at least one of CeO₂, Nb₂O₅, SiN, SnO₂, SnS, TiO₂, ZnO, ZnS and ZrO₂, or a mixture containing at least one of CeO₂, Nb₂O₅, SiN, SnO₂, SnS, TiO₂, ZnO, ZnS and ZrO₂. In addition, the dry deposited nₕ dielectric layer has a thickness between 0.1 QW-4.0 QW for a desired control wavelength, the desired control wavelength being a center wavelength for a desired color reflection band. The dry deposited absorber layer is made from at least one of Cr, Cu, Au, Sn, alloys thereof, amorphous Si, Fe₂O₃, and the like, and can have a thickness between 2-30 nm. The wet deposited nₕ outer oxide layer is made from at least one of CeO₂, Nb₂O₅, SnO₂, TiO₂, ZnO and ZrO₂, and can have a thickness between 5-200 nm.

In some instances, the multilayer has a central reflector core layer and a pair of dry deposited nₕ dielectric layers oppositely disposed from each other and bounding said reflective core layer. In addition, a pair of absorber layers can be oppositely disposed from each other and bound the pair of dry deposited nₕ dielectric layers. Also, the wet deposited nₕ outer oxide layer can extend across outer surfaces of the pair of absorber layers.

The hybrid omnidirectional structural color pigment has a thickness of less than 2.0 μm, and in some instances has a thickness of less than 1.5 μm. The pigment, and thus the multilayer stack, can also have less than 10 total layers, and in some instances have less than 8 total layers.

A process for making an omnidirectional structural color pigment is also provided. The process includes manufacturing the multilayer stack discussed above by providing a reflective core layer and dry depositing a nₕ dielectric layer that extends across the reflective core layer. In addition, the process includes dry depositing a absorber layer that extends across the nₕ dielectric layer and wet depositing an outer nₕ oxide layer that extends across the absorber layer.

### BRIEF DESCRIPTION OF THE FIGURES

FIG. 1 is a schematic illustration of an omnidirectional structural color multilayer stack made from a dielectric layer, a selective absorbing layer (SAL) and a reflector layer;

FIG. 2A is a schematic illustration of a zero or near-zero electric field point within a ZnS dielectric layer exposed to electromagnetic radiation (EMR) having a wavelength of 500 nm;

FIG. 2B is a graphical illustration of the absolute value of electric field squared (|E|²) versus thickness of the ZnS dielectric layer shown in FIG. 2A when exposed to EMR having wavelengths of 300, 400, 500, 600 and 700 nm;

FIG. 3 is a schematic illustration of a dielectric layer extending over a substrate or reflector layer and exposed to electromagnetic radiation at an angle θ relative to a normal direction to the outer surface of the dielectric layer;

FIG. 4 is a schematic illustration of a ZnS dielectric layer with a Cr absorber layer located at the zero or near-zero electric field point within the ZnS dielectric layer for incident EMR having a wavelength of 434 nm;

FIG. 5 is a graphical representation of percent reflectance versus reflected EMR wavelength for a multilayer stack without a Cr absorber layer (e.g., FIG. 2A) and a multilayer stack with a Cr absorber layer (e.g., FIG. 4) exposed to white light;

FIG. 6A is a graphical illustration of first harmonics and second harmonics exhibited by a ZnS dielectric layer extending over an Al reflector layer (e.g., FIG. 2A);

FIG. 6B is a graphical illustration of percent reflectance versus reflected EMR wavelength for a multilayer stack with a ZnS dielectric layer extending across an Al reflector layer, plus a Cr absorber layer located within the ZnS dielectric layer such that the second harmonics shown in FIG. 6A are absorbed;

FIG. 6C is a graphical illustration of percent reflectance versus reflected EMR wavelength for a multilayer stack with a ZnS dielectric layer extending across an Al reflector layer, plus a Cr absorber layer located within the ZnS dielectric layer such that the first harmonics shown in FIG. 6A are absorbed;

FIG. 7A is a graphical illustration of electric field squared versus dielectric layer thickness showing the electric field angular dependence of a Cr absorber layer for exposure to incident light at 0 and 45 degrees;

FIG. 7B is a graphical illustration of percent absorbance by a Cr absorber layer versus reflected EMR wavelength when exposed to white light at 0 and 45° angles relative to normal of the outer surface (0° being normal to surface);

FIG. 8A is a schematic illustration of a red omnidirectional structural color multilayer stack according to an embodiment disclosed herein;

FIG. 8B is a graphical illustration of percent absorbance of the Cu absorber layer shown in FIG. 8A versus reflected EMR wavelength for white light exposure to the multilayer stack shown in FIG. 10A at incident angles of 0 and 45°;

FIG. 9 is a graphical comparison between calculation/simulation data and experimental data for percent reflectance versus reflected EMR wavelength for a proof of concept red omnidirectional structural color multilayer stack exposed to white light at an incident angle of 0°;

FIG. 10 is a graphical illustration of percent reflectance versus wave length for an omnidirectional structural color multilayer stack according to an embodiment disclosed herein;

FIG. 11 is a graphical illustration of percent reflectance versus wave length for an omnidirectional structural color multilayer stack according to an embodiment disclosed herein;

FIG. 12 is a graphical illustration of percent reflectance versus wave length for an omnidirectional structural color multilayer stack according to an embodiment disclosed herein;

FIG. 13 is a graphical illustration of percent reflectance versus wave length for an omnidirectional structural color multilayer stack according to an embodiment disclosed herein;

FIG. 14 is a graphical representation of a portion of an a*b* color map using the CIELAB color space in which the chroma and hue shift of a conventional paint and a paint made from pigments according to an embodiment disclosed herein are compared (Sample (b));

FIG. 15 is a schematic illustration of an omnidirectional structural color multilayer stack according to an embodiment disclosed herein;

FIG. 16 is a schematic illustration of a five-layer omnidirectional structural color pigment having a protective coating according to an embodiment disclosed herein;

FIG. 17 is a schematic illustration of a protective coating containing two or more layers according to an embodiment disclosed herein;

FIG. 18 is a schematic illustration of an omnidirectional structural color multilayer stack according to an embodiment disclosed herein; and

FIG. 19 is a schematic illustration of a seven-layer omnidirectional structural color pigment having a protective coating according to an embodiment disclosed herein.

### DETAILED DESCRIPTION OF THE INVENTION

An omnidirectional structural color pigment is provided. The omnidirectional structural color has the form of a multilayer stack (also referred to as a multilayer thin film herein) that reflects a narrow band of electromagnetic radiation in the visible spectrum and has a small or non-noticeable color shift when the multilayer stack is viewed by the human eye from angles between 0 to 45 degrees. In more technical terms, the multilayer stack reflects a narrow band of visible electromagnetic radiation with a width of less than 300 nm when exposed to white light. In addition, the narrow band of reflected visible light shifts less than 30° on an a*b* color map using the CIELAB color space when the pigment is view from angles between 0 to 45 degrees relative to normal of an outer surface of the multilayer stack.

The multilayer stack has a reflector core layer, a high index of refraction (nₕ) dielectric layer that extends across the reflector core layer, an absorber layer that extends across the nₕ dielectric layer and an nₕ outer protective layer that extends across the absorber layer. In some instances, the narrow band of reflected electromagnetic radiation has a FWHM defined below of less than 200 nm and in other instances less than 150 nm. The multilayer stack can also have a color shift of less than 20°, and in some instance less than 15° on the a*b* color map.

Another measure of the color shift is a shift of a center wavelength of the narrow reflection band. In such terms, a center wavelength of the narrow band of reflected visible light shifts less than 50 nm, preferably less than 40 nm and more preferably less than 30 nm, when the multilayer stack is exposed to broadband electromagnetic radiation and viewed from angles between 0 and 45 degrees relative to the normal of an outer surface of the multilayer stack. Also, the multilayer stack may or may not have a separate reflected band of electromagnetic radiation in the UV range and/or the IR range.

The overall thickness of the multilayer stack is less than 2 μm, preferably less than 1.5 μm, and still more preferably less than 1.0 μm. As such, the multilayer stack can be used as paint pigment in thin film paint coatings.

The multilayer stack can also include a reflector core layer which the first layer and the second layer extend across and the reflector core layer cane be made from metals such as Al, Ag, Pt, Cr, Cu, Zn, Au, Sn, alloys thereof, and the like. The reflector core layer typically has a thickness between 30-200 nm.

The first layer is made from a nₕ dielectric material and the second layer is made from an absorbing material. The nₕ dielectric material can include but is not limited to CeO₂, Nb₂O₅, SiN, SnO₂, SnS, TiO₂, ZnO, ZnS and ZrO₂. The absorbing material can include selective absorbing materials such as Cu, Au, Zn, Sn, alloys thereof, and the like, or in the alternative colorful dielectric materials such as Fe₂O₃, Cu₂O, combinations thereof, and the like. The absorbing material can also be a non-selective absorbing material such as Cr, Ta, W, Mo, Ti, Ti-nitride, Nb, Co, Si, Ge, Ni, Pd, V, ferric oxides, combinations or alloys thereof, and the like. The outer protective layer can include but is not limited to CeO₂, Nb₂O₅, SnO₂, TiO₂, ZnO and ZrO₂.

The thickness of the nₕ dielectric layer can be between 0.1 QW-4.0 QW for a desired control wavelength. The thickness of an absorbing layer made from selective absorbing material is between 20-80 nm whereas the thickness of an absorbing layer made from non-selective absorbing material is between 5-30 nm. The thickness of the outer protective layer can be between 5-200 nm.

The multilayer stack can have a reflected narrow band of electromagnetic radiation that has the form of a symmetrical peak within the visible spectrum. In the alternative, the reflected narrow band of electromagnetic radiation in the visible spectrum can be adjacent to the UV range such that a portion of the reflected band of electromagnetic radiation, i.e. the UV portion, is not visible to the human eye. In another alternative, the reflected band of electromagnetic radiation can have a portion in the IR range such that the IR portion is not visible to the human eye.

Whether the reflected band of electromagnetic radiation that is in the visible spectrum borders the UV range, the IR range, or has a symmetrical peak within the visible spectrum, multilayer stacks disclosed herein have a reflected narrow band of electromagnetic radiation in the visible spectrum that has a low, small or non-noticeable color shift. The low or non-noticeable color shift can be in the form of a small shift of a center wavelength for a reflected narrow band of electromagnetic radiation. In the alternative, the low or non-noticeable color shift can be in the form of a small shift of a UV-sided edge or IR-sided edge of a reflected band of electromagnetic radiation that borders the IR range or UV range, respectively. Such a small shift of a center wavelength, UV-sided edge and/or IR-sided edge is typically less than 50 nm, in some instances less than 40 nm, and in other instances less than 30 nm when the multilayer stack is viewed from angles between 0 and 45 degrees relative to the normal of an outer surface of the multilayer stack. The low or non-noticeable color shift can also be in the form of a small hue shift on an a*b* color map using the CIELAB color space. For example, in some instances the hue shift for the multilayer stack is less than 30°, preferably less than 25°, more preferably less than 20°, still more preferably less than 15° and even still more preferably less than 10°.

In addition to the above, the omnidirectional structural color in the form of a multilayer stack can be in the form of a plurality of pigment particles with the outer protective coating thereon, e.g. a weather resistant coating. The outer protective coating can include one or more nₕ oxide layers that reduce the relative photocatalytic activity of the pigment particles. In some instances, the outer protective coating includes a first oxide layer and a second oxide layer. In addition, the first oxide layer and/or the second oxide layer can be a hybrid oxide layer, i.e. an oxide layer that is a combination of two different oxides.

A process for producing the omnidirectional structural color pigment may or may not include the use of an acid, an acidic compound, acidic solution, and the like. Stated differently, the plurality of omnidirectional structural color pigment particles may or may not be treated in an acidic solution. Additional teachings and details of the omnidirectional structural color pigment and a process for manufacturing the pigment are discussed later in the instant document.

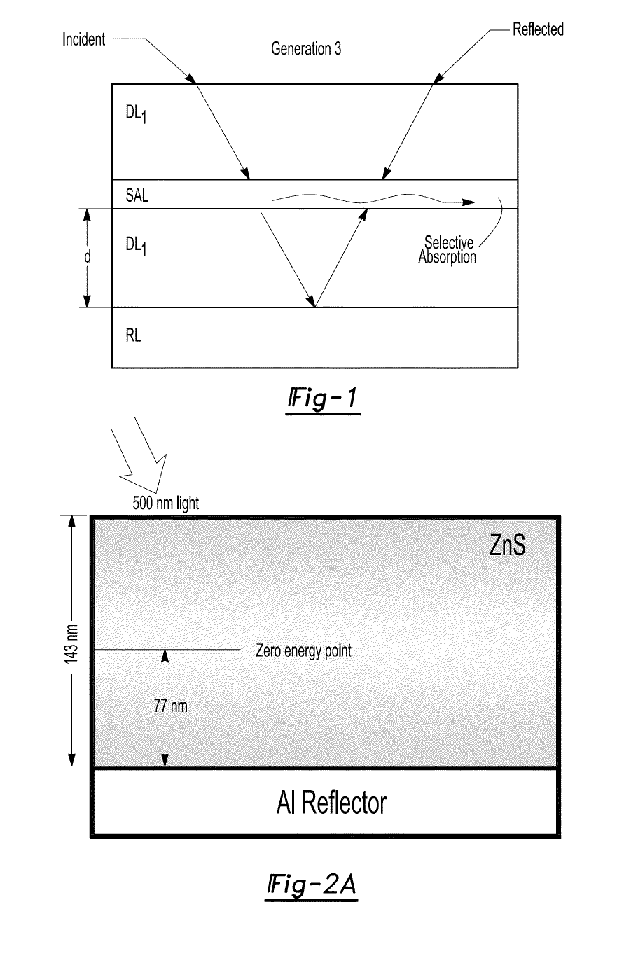

Referring to FIG. 1, a design is shown in which an underlying reflector layer (RL) has a first dielectric material layer DL₁ extending thereacross and a selective absorbing layer SAL extending across the DL₁ layer. In addition, another DL₁ layer may or may not be provided and extend across the selective absorbing layer. Also shown in the figure is an illustration that all of the incident electromagnetic radiation is either reflected or selectively absorbed by the multilayer structure.

Such a design as illustrated in FIG. 1 corresponds to a different approach that is used for designing and manufacturing a desired multilayer stack. In particular, a zero or near-zero energy point thickness for a dielectric layer is used and discussed below.

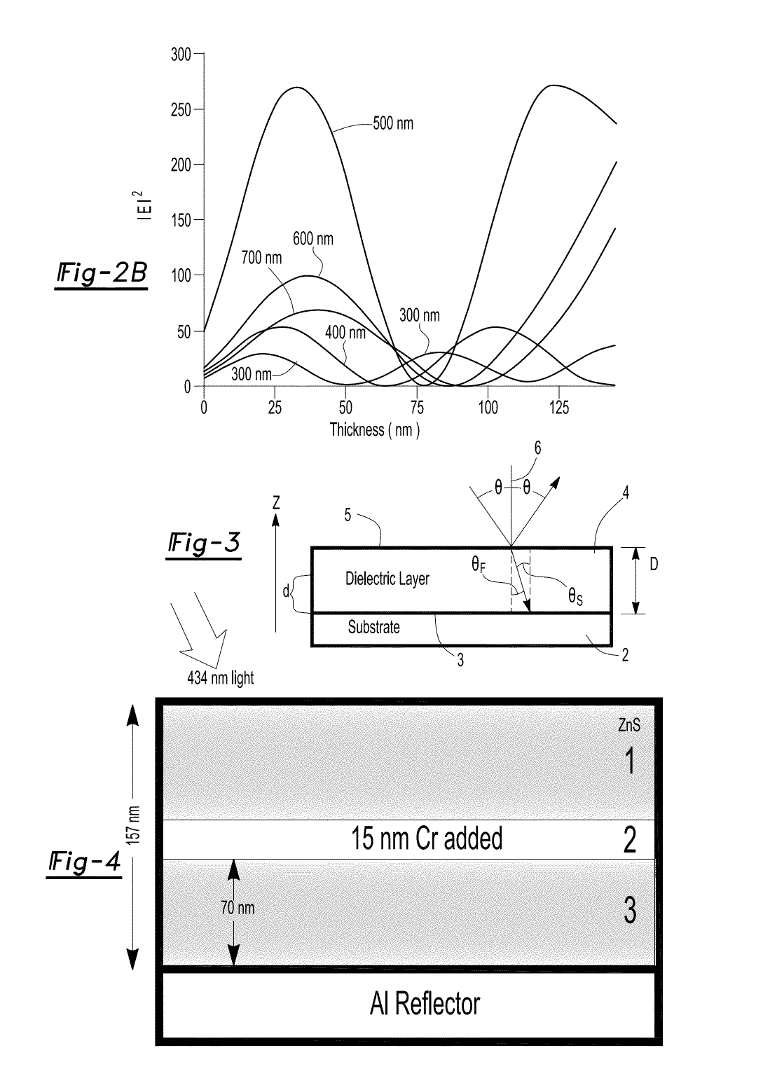

For example, FIG. 2A is a schematic illustration of a ZnS dielectric layer extending across an Al reflector core layer. The ZnS dielectric layer has a total thickness of 143 nm, and for incident electromagnetic radiation with a wavelength of 500 nm, a zero or near-zero energy point is present at 77 nm. Stated differently, the ZnS dielectric layer exhibits a zero or near-zero electric field at a distance of 77 nm from the Al reflector layer for incident electromagnetic radiation (EMR) having a wavelength of 500 nm. In addition, FIG. 2B provides a graphical illustration of the energy field across the ZnS dielectric layer for a number of different incident EMR wavelengths. As shown in the graph, the dielectric layer has a zero electric field for the 500 nm wavelength at 77 nm thickness, but a non-zero electric field at the 77 nm thickness for EMR wavelengths of 300, 400, 600 and 700 nm.

Regarding calculation of a zero or near-zero electric field point, FIG. 3 illustrates a dielectric layer 4 having a total thickness ‘ID’, an incremental thickness ‘d’ and an index of refraction ‘n’ on a substrate or core layer 2 having an index of refraction nₛ. Incident light strikes the outer surface 5 of the dielectric layer 4 at angle θ relative to line 6, which is perpendicular to the outer surface 5, and reflects from the outer surface 5 at the same angle θ. Incident light is transmitted through the outer surface 5 and into the dielectric layer 4 at an angle θ_{F} relative to the line 6 and strikes the surface 3 of substrate layer 2 at an angle θₛ.

For a single dielectric layer, θₛ=θ_{F} and the energy/electric field (E) can be expressed as E(z) when z=d. From Maxwell's equations, the electric field can be expressed for s polarization as:

\vec{E}(d)={u(z),0,0}exp(ikαy)|_{z=d} (1)

and for p polarization as:

$$\vec{E} ( d ) = \{ 0 , u ( z ) , - \frac{α}{\tilde{ɛ} ( z )} v ( z ) \} exp ( i k α y ) {\vert}_{z = d} \qquad ( 2 )$$

where

$$k = \frac{2 π}{λ}$$

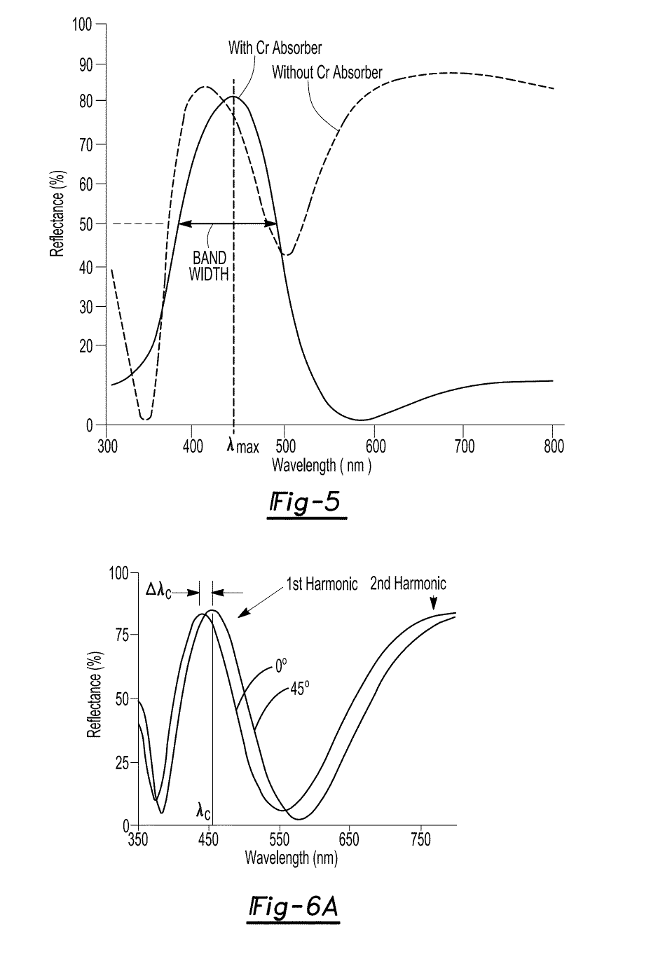

and λ is a desired wavelength to be reflected. Also, α=nₛ sin θₛ where ‘s’ corresponds to the substrate in FIG. 5 and \tilde{∈}(z) is the permittivity of the layer as a function of z. As such,

|E(d)|²=|u(z)|²exp(2ikαy)|_{z=d} (3)

for s polarization and

$${\vert E ( d ) \vert}^{2} = [ {\vert u ( z ) \vert}^{2} + {\vert \frac{α}{\sqrt{n}} v ( z ) \vert}^{2} ] exp ( 2 i k α y ) {\vert}_{z = d} \qquad ( 4 )$$

for p polarization.

It is appreciated that variation of the electric field along the Z direction of the dielectric layer 4 can be estimated by calculation of the unknown parameters u(z) and v(z) where it can be shown that:

$${( \begin{matrix}u \\ v\end{matrix} )}_{z = d} = ( \begin{matrix}cos ϕ & ( i / q ) sin ϕ \\ i q sin ϕ & cos ϕ\end{matrix} ) {( \begin{matrix}u \\ v\end{matrix} )}_{z = 0 , substrate} \qquad ( 5 )$$

Naturally, ‘i’ is the square root of −1. Using the boundary conditions u|_{z=0}=1, v|_{z=0}=qₛ, and the following relations:

qₛ=nₛ cos θₛ for s-polarization (6)

qₛ=nₛ/cos θₛ for p-polarization (7)

q=n cos θ_{F} for s-polarization (8)

q=n/cos θ_{F} for p-polarization (9)

φ=k·n·d cos(θ_{F}) (10)

u(z) and v(z) can be expressed as:

$$\begin{matrix}\begin{matrix}u ( z ) {\vert}_{z = d} = u {\vert}_{z = 0} cos ϕ + v {\vert}_{z = o} ( \frac{i}{q} sin ϕ ) \\ = cos ϕ + \frac{i \cdot {q}_{s}}{q} sin ϕ\end{matrix} & ( 11 ) \\ and & \\ \begin{matrix}v ( z ) {\vert}_{z = d} = i qu {\vert}_{z = 0} sin ϕ + v {\vert}_{z = 0} cos ϕ \\ = i q sin ϕ + {q}_{s} cos ϕ\end{matrix} & ( 12 ) \\ Therefore \text{:} & \\ \begin{matrix}{\vert E ( d ) \vert}^{2} = [ {cos}^{2} ϕ + \frac{{q}_{s}^{2}}{{q}^{2}} {sin}^{2} ϕ ] {e}^{2 i k α γ} \\ = [ {cos}^{2} ϕ + \frac{{n}_{s}^{2}}{{n}^{2}} {sin}^{2} ϕ ] {e}^{2 i k α γ}\end{matrix} & ( 13 )\end{matrix}$$

for s polarization with φ=k·n·d cos(θ_{F}), and:

$$\begin{matrix}{\vert E ( d ) \vert}^{2} = [ {cos}^{2} ϕ + \frac{{n}_{s}^{2}}{{n}^{2}} {sin}^{2} ϕ + \frac{{α}^{2}}{n} ( {q}_{s}^{2} {cos}^{2} ϕ + {q}^{2} {sin}^{2} ϕ ) ] \\ = [ ( 1 + \frac{{α}^{2} {q}_{s}^{2}}{n} ) {cos}^{2} ϕ + ( \frac{{n}_{s}^{2}}{{n}^{2}} + \frac{{α}^{2} {q}^{2}}{n} ) {sin}^{2} ϕ ]\end{matrix} \qquad ( 14 )$$

for p polarization where:

$$\begin{matrix}α = {n}_{s} sin {θ}_{s} = n sin {θ}_{F} & ( 15 ) \\ {q}_{s} = \frac{{n}_{s}}{cos {θ}_{s}} & ( 16 ) \\ and & \\ {q}_{s} = \frac{n}{cos {θ}_{F}} & ( 17 )\end{matrix}$$

Thus for a simple situation where θ_{F}=0 or normal incidence, φ=k·n·d, and α=0:

$$\begin{matrix}{\vert E ( d ) \vert}^{2} for s \text{-} polarization = {\vert E ( d ) \vert}^{2} for p \text{-} polarization & \\ = [ {cos}^{2} ϕ + \frac{{n}_{s}^{2}}{{n}^{2}} {sin}^{2} ϕ ] & ( 18 ) \\ = [ {cos}^{2} ( k \cdot n \cdot d ) + \frac{{n}_{s}^{2}}{{n}^{2}} {sin}^{2} ( k \cdot n \cdot d ) ] & ( 19 )\end{matrix}$$

which allows for the thickness ‘d’ to be solved for, i.e. the position or location within the dielectric layer where the electric field is zero.

Referring now to FIG. 4, Equation 19 was used to calculate that the zero or near-zero electric field point in the ZnS dielectric layer shown in FIG. 2A when exposed to EMR having a wavelength of 434 nm. The zero or near-zero electric field point was calculated to be 70 nm (instead of 77 nm for a 500 nm wavelength). In addition, a 15 nm thick Cr absorber layer was inserted at the thickness or distance of 70 nm from the Al reflector core layer to afford for a zero or near-zero electric field ZnS—Cr interface. Such an inventive structure allows light having a wavelength of 434 nm to pass through the Cr—ZnS interfaces, but absorbs light not having a wavelength of 434 nm. Stated differently, the Cr—ZnS interfaces have a zero or near-zero electric field with respect to light having a wavelength of 434 nm and thus 434 nm light passes through the interfaces. However, the Cr—ZnS interfaces do not have a zero or near-zero electric field for light not having a wavelength of 434 nm and thus such light is absorbed by the Cr absorber layer and/or Cr—ZnS interfaces and not reflected by the Al reflector layer.

It is appreciated that some percentage of light within +/−10 nm of the desired 434 nm will pass through the Cr—ZnS interface. However, it is also appreciated that such a narrow band of reflected light, e.g. 434+/−10 nm, still provides a sharp structural color to a human eye.

The result of the Cr absorber layer in the multilayer stack in FIG. 4 is illustrated in FIG. 5 where percent reflectance versus reflected EMR wavelength is shown. As shown by the dotted line, which corresponds to the ZnS dielectric layer shown in FIG. 4 without a Cr absorber layer, a narrow reflected peak is present at about 400 nm, but a much broader peak is present at about 550+ nm. In addition, there is still a significant amount of light reflected in the 500 nm wavelength region. As such, a double peak that prevents the multilayer stack from having or exhibiting a structural color is present.

In contrast, the solid line in FIG. 5 corresponds to the structure shown in FIG. 4 with the Cr absorber layer present. As shown in the figure, a sharp peak at approximately 434 nm is present and a sharp drop off in reflectance for wavelengths greater than 434 nm is afforded by the Cr absorber layer. It is appreciated that the sharp peak represented by the solid line visually appears as sharp/structural color. Also, FIG. 5 illustrates where the width of a reflected peak or band is measured, i.e. the width of the band is determined at 50% reflectance of the maximum reflected wavelength, also known as full width at half maximum (FWHM).

Regarding omnidirectional behavior of the multilayer structure shown in FIG. 4, the thickness of the ZnS dielectric layer can be designed or set such that only the first harmonics of reflected light is provided. It is appreciated that this is sufficient for a “blue” color, however the production of a “red” color requires additional considerations. For example, the control of angular independence for red color is difficult since thicker dielectric layers are required, which in turn results in a high harmonic design, i.e. the presence of the second and possible third harmonics is inevitable. Also, the dark red color hue space is very narrow. As such, a red color multilayer stack has a higher angular variance.

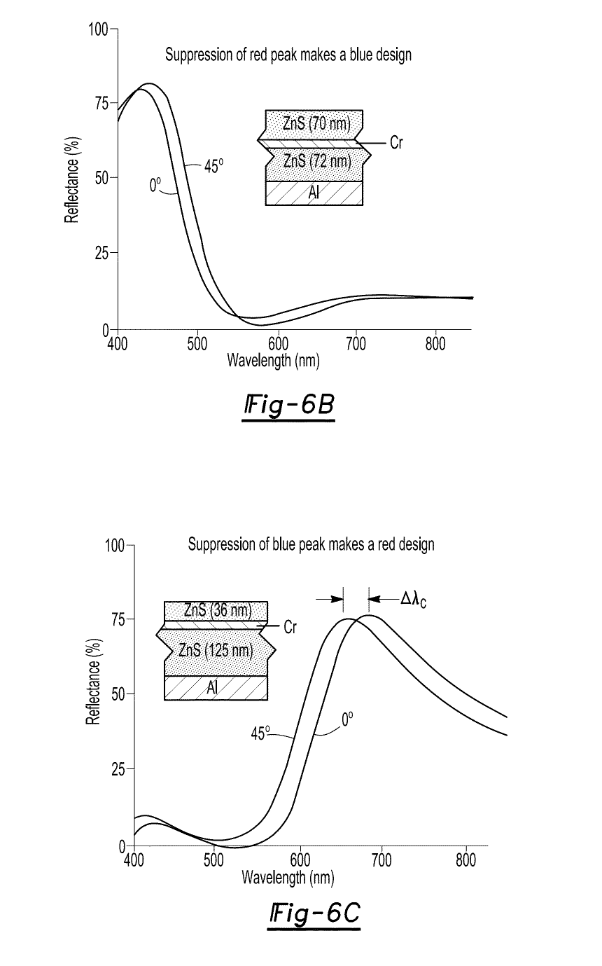

In order to overcome the higher angular variance for red color, the instant application discloses a unique and novel design/structure that affords for a red color that is angular independent. For example, FIG. 6A illustrates a dielectric layer exhibiting first and second harmonics for incident white light when an outer surface of the dielectric layer is viewed from 0 and 45 degrees relative to the normal of the outer surface. As shown by the graphical representation, low angular dependence (small Δλ_{c}) is provided by the thickness of the dielectric layer, however, such a multilayer stack has a combination of blue color (1^{st} harmonic) and red color (2^{nd} harmonic) and thus is not suitable for a desired “red only” color. Therefore, the concept/structure of using an absorber layer to absorb an unwanted harmonic series has been developed. FIG. 6A also illustrates an example of the location of the reflected band center wavelength (λ_{c}) for a given reflection peak and the dispersion or shift of the center wavelength (Δλ_{c}) when the sample is viewed from 0 and 45 degrees.

Turning now to FIG. 6B, the second harmonic shown in FIG. 6A is absorbed with a Cr absorber layer at the appropriate dielectric layer thickness (e.g. 72 nm) and a sharp blue color is provided. Also, FIG. 6C illustrates that by absorbing the first harmonics with the Cr absorber at a different dielectric layer thickness (e.g. 125 nm) a red color is provided. However, FIG. 6C also illustrates that the use of the Cr absorber layer can result in more than desired angular dependence by the multilayer stack, i.e. a larger than desired Δλ_{c}.

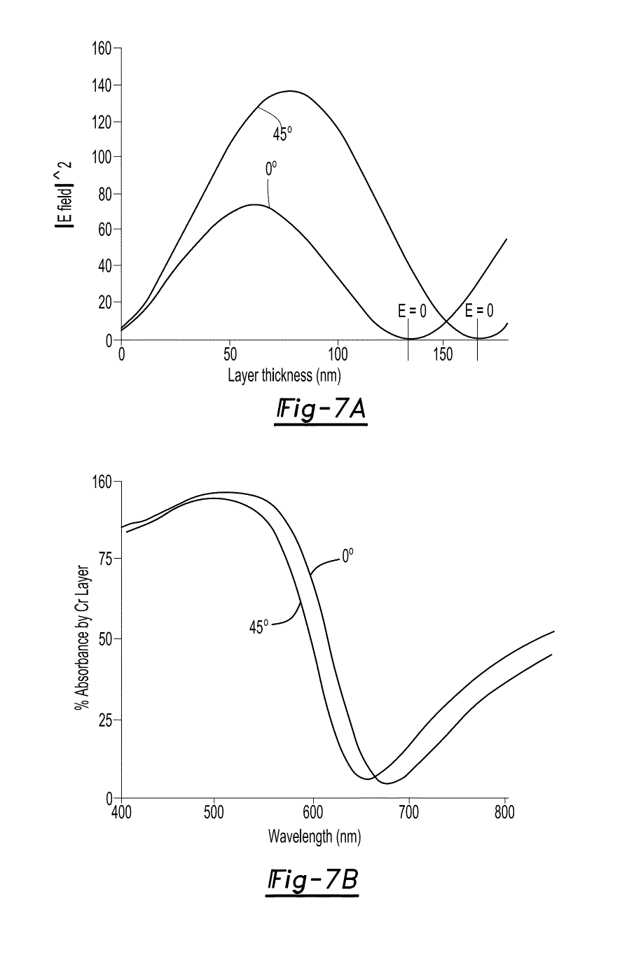

It is appreciated that the relatively large shift in λ_{c} for the red color compared to the blue color is due to the dark red color hue space being very narrow and the fact that the Cr absorber layer absorbs wavelengths associated with a non-zero electric field, i.e. does not absorb light when the electric field is zero or near-zero. As such, FIG. 7A illustrates that the zero or non-zero point is different for light wavelengths at different incident angles. Such factors result in the angular dependent absorbance shown in FIG. 7B, i.e. the difference in the 0° and 45° absorbance curves. Thus in order to further refine the multilayer stack design and angular independence performance, an absorber layer that absorbs, e.g. blue light, irrespective of whether or not the electric field is zero or not, is used.

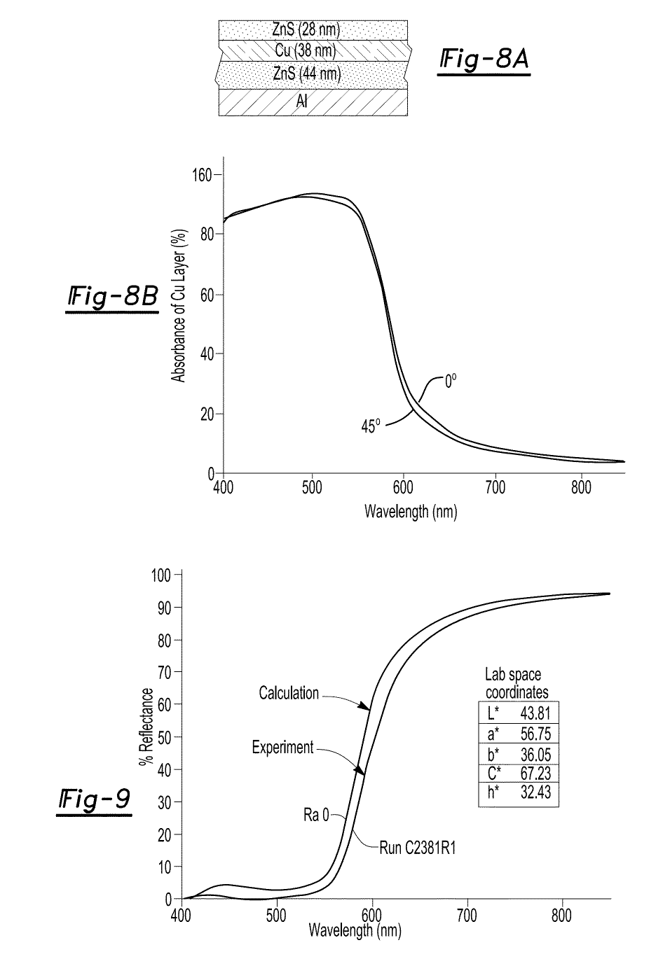

In particular, FIG. 8A shows a multilayer stack with a Cu absorber layer instead of a Cr absorber layer extending across a dielectric ZnS layer. The results of using such a “colorful” or “selective” absorber layer is shown in FIG. 8B which demonstrates a much “tighter” grouping of the 0° and 45° absorbance lines for the multilayer stack shown in FIG. 8A. As such, a comparison between FIG. 8B and FIG. 7B illustrates the significant improvement in absorbance angular independence when using a selective absorber layer rather than non-selective absorber layer.

Based on the above, a proof of concept multilayer stack structure was designed and manufactured. In addition, calculation/simulation results and actual experimental data for the proof of concept sample were compared. In particular, and as shown by the graphical plot in FIG. 9, a sharp red color was produced (wavelengths greater than 700 nm are not typically seen by the human eye) and very good agreement was obtained between the calculation/simulation and experimental light data obtained from the actual sample. Stated differently, calculations/simulations can and/or are used to simulate the results of multilayer stack designs according to one or more embodiments disclosed herein and/or prior art multilayer stacks.

A list of simulated and/or actually produced multilayer stack samples is provided in the Table 1 below. As shown in the table, the inventive designs disclosed herein include at least 5 different layered structures. In addition, the samples were simulated and/or made from a wide range of materials. Samples that exhibited high chroma, low hue shift (Ah) and excellent reflectance were provided. Also, the three and five layer samples had an overall thickness between 120-200 nm; the seven layer samples had an overall thickness between 350-600 nm; the nine layer samples had an overall thickness between 440-500 nm; and the eleven layer samples had an overall thickness between 600-660 nm.

TABLE 1

| | Ave. | | | |
|---|---|---|---|---|
| | Chroma | | Max. | Sample |
| | (0-45) | Δh (0-65) | Reflectance | Name |
| 3 layer | 90 | 2 | 96 | 3-1 |
| 5 layer | 91 | 3 | 96 | 5-1 |
| 7 layer | 88 | 1 | 92 | 7-1 |
| | 91 | 3 | 92 | 7-2 |
| | 91 | 3 | 96 | 7-3 |
| | 90 | 1 | 94 | 7-4 |
| | 82 | 4 | 75 | 7-5 |
| | 76 | 20 | 84 | 7-6 |
| 9 layer_{[DB1][MH2]} | 71 | 21 | 88 | 9-1 |
| | 95 | 0 | 94 | 9-2 |
| | 79 | 14 | 86 | 9-3 |
| | 90 | 4 | 87 | 9-4 |
| | 94 | 1 | 94 | 9-5 |
| | 94 | 1 | 94 | 9-6 |
| | 73 | 7 | 87 | 9-7 |
| 11 layer | 88 | 1 | 84 | 11-1 |
| | 92 | 1 | 93 | 11-2 |
| | 90 | 3 | 92 | 11-3 |
| | 89 | 9 | 90 | 11-4_{[DB3]} |

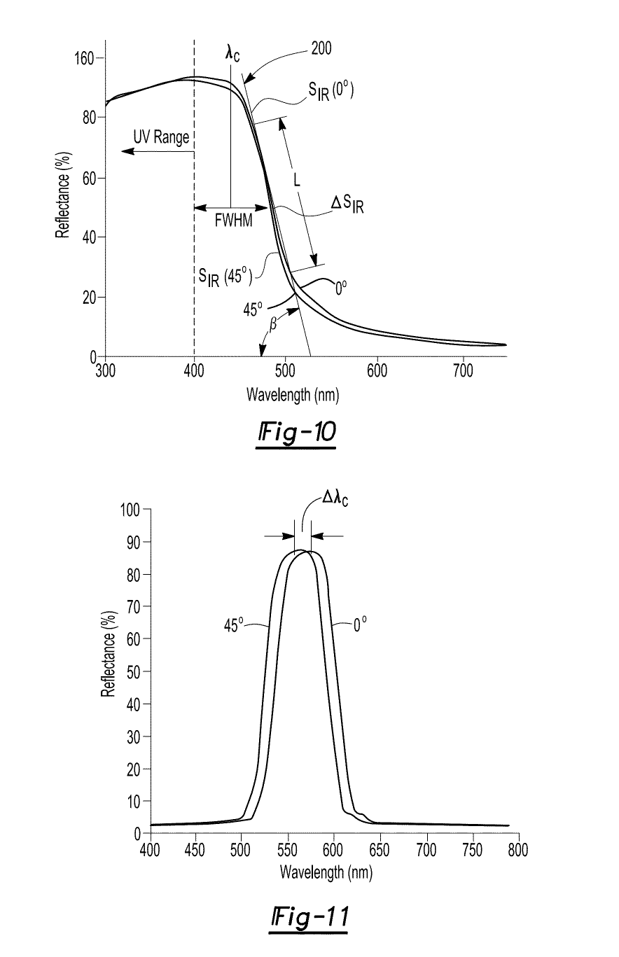

Turning now to FIG. 10, a plot of percent reflectance versus reflected EMR wavelength is shown for an omnidirectional reflector when exposed to white light at angles of 0 and 45° relative to the normal of the outer surface of the reflector. As shown by the plot, both the 0° and 45° curves illustrate very low reflectance, e.g. less than 20%, provided by the omnidirectional reflector for wavelengths greater than 500 nm. However, the reflector, as shown by the curves, provides a sharp increase in reflectance at wavelengths between 400-500 nm and reaches a maximum of approximately 90% at 450 nm. It is appreciated that the portion or region of the graph on the left hand side (UV side) of the curve represents the UV-portion of the reflection band provided by the reflector.

The sharp increase in reflectance provided by the omnidirectional reflector is characterized by an IR-sided edge of each curve that extends from a low reflectance portion at wavelengths greater than 500 nm up to a high reflectance portion, e.g. >70%. A linear portion 200 of the IR-sided edge is inclined at an angle (β) greater than 60° relative to the x-axis, has a length L of approximately 50 on the Reflectance-axis and a slope of 1.2. In some instances, the linear portion is inclined at an angle greater than 70° relative to the x-axis, while in other instances β is greater than 75°. Also, the reflection band has a visible FWHM of less than 200 nm, and in some instances a visible FWHM of less than 150 nm, and in other instances a visible FWHM of less than 100 nm. In addition, the center wavelength λ_{c} for the visible reflection band as illustrated in FIG. 10 is defined as the wavelength that is equal-distance between the IR-sided edge of the reflection band and the UV edge of the UV spectrum at the visible FWHM.

The term “visible FWHM” refers to the width of the reflection band between the IR-sided edge of the curve and the edge of the UV spectrum range, beyond which reflectance provided by the omnidirectional reflector is not visible to the human eye. In this manner, the inventive designs and multilayer stacks disclosed herein use the non-visible UV portion of the electromagnetic radiation spectrum to provide a sharp or structural color. Stated differently, the omnidirectional reflectors disclosed herein can take advantage of the non-visible UV portion of the electromagnetic radiation spectrum in order to provide a narrow band of reflected visible light, despite the fact that the reflectors may reflect a much broader band of electromagnetic radiation that extends into the UV region.

Turning now to FIG. 11, a generally symmetrical reflection band provided by a multilayer stack according to an embodiment disclosed herein and when viewed at 0° and 45° is shown. As illustrated in the figure, the reflection band provided by the multilayer stack has a center wavelength λ_{c} (0°) when viewed at 0° and a center wavelength λ_{c} (45°) when viewed at 45°. Also, the center wavelength shifts less than 50 nm when the multilayer stack is viewed at angles between 0 and 45°, i.e. Δλ_{c} (0-45°)<50 nm. In addition, the FWHM of both the 0° reflection band and the 45° reflection band is less than 200 nm.

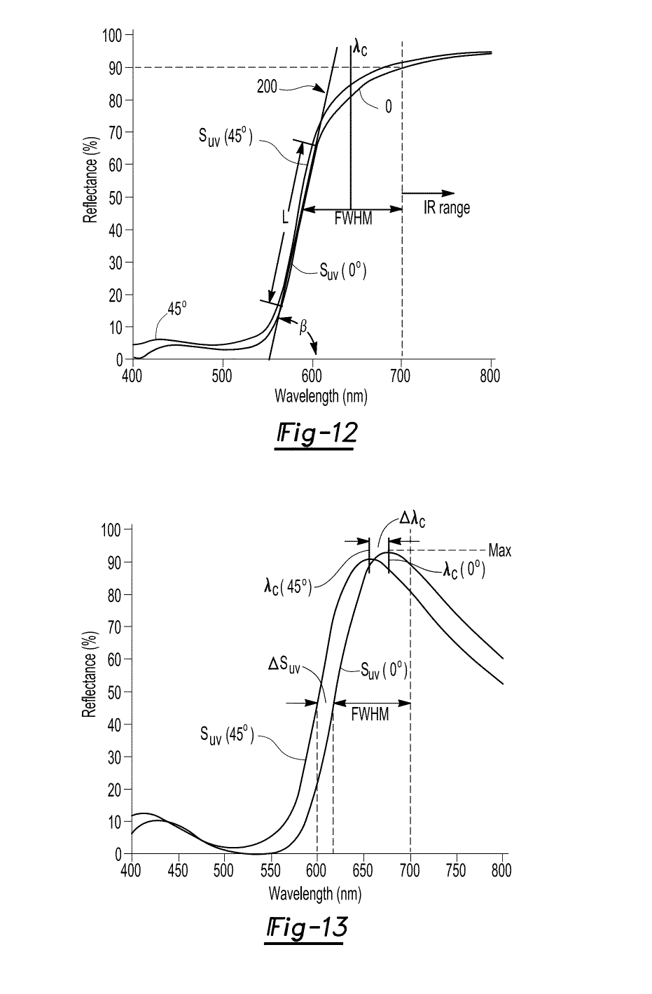

FIG. 12 shows a plot of percent reflectance versus reflected EMR wavelength for another omnidirectional reflector design when exposed to white light at angles of 0 and 45° relative to the normal of the outer surface of the reflector. As shown by the plot, both the 0° and 45° curves illustrate very low reflectance, e.g. less than 10%, provided by the omnidirectional reflector for wavelengths less than 550 nm. However, the reflector, as shown by the curves, provides a sharp increase in reflectance at wavelengths between 560-570 nm and reaches a maximum of approximately 90% at 700 nm. It is appreciated that the portion or region of the graph on the right hand side (IR side) of the curve represents the IR-portion of the reflection band provided by the reflector.

The sharp increase in reflectance provided by the omnidirectional reflector is characterized by a UV-sided edge of each curve that extends from a low reflectance portion at wavelengths below 550 nm up to a high reflectance portion, e.g. >70%. A linear portion 200 of the UV-sided edge is inclined at an angle (β) greater than 60° relative to the x-axis, has a length L of approximately 40 on the Reflectance-axis and a slope of 1.4. In some instances, the linear portion is inclined at an angle greater than 70° relative to the x-axis, while in other instances β is greater than 75°. Also, the reflection band has a visible FWHM of less than 200 nm, and in some instances a visible FWHM of less than 150 nm, and in other instances a visible FWHM of less than 100 nm. In addition, the center wavelength λ_{c} for the visible reflection band as illustrated in FIG. 12 is defined as the wavelength that is equal-distance between the UV-sided edge of the reflection band and the IR edge of the IR spectrum at the visible FWHM.

It is appreciated that the term “visible FWHM” refers to the width of the reflection band between the UV-sided edge of the curve and the edge of the IR spectrum range, beyond which reflectance provided by the omnidirectional reflector is not visible to the human eye. In this manner, the inventive designs and multilayer stacks disclosed herein use the non-visible IR portion of the electromagnetic radiation spectrum to provide a sharp or structural color. Stated differently, the omnidirectional reflectors disclosed herein take advantage of the non-visible IR portion of the electromagnetic radiation spectrum in order to provide a narrow band of reflected visible light, despite the fact that the reflectors may reflect a much broader band of electromagnetic radiation that extends into the IR region.

Referring now to FIG. 13, a plot of percent reflectance versus wavelength is shown for another seven-layer design omnidirectional reflector when exposed to white light at angles of 0 and 45° relative to the surface of the reflector. In addition, a definition or characterization of omnidirectional properties provided by omnidirectional reflectors disclosed herein is shown. In particular, and when the reflection band provided by an inventive reflector has a maximum, i.e. a peak, as shown in the figure, each curve has a center wavelength (λ_{c}) defined as the wavelength that exhibits or experiences maximum reflectance. The term maximum reflected wavelength can also be used for λ_{c}.

As shown in FIG. 13, there is shift or displacement of λ_{c} when an outer surface of the omnidirectional reflector is observed from an angle 45° (λ_{c}(45°)), e.g. the outer surface is tiled 45° relative to a human eye looking at the surface, compared to when the surface is observed from an angle of 0° ((λ_{c}(0°)), i.e. normal to the surface. This shift of λ_{c} (Δλ_{c}) provides a measure of the omnidirectional property of the omnidirectional reflector. Naturally a zero shift, i.e. no shift at all, would be a perfectly omnidirectional reflector. However, omnidirectional reflectors disclosed herein can provide a Δλ_{c} of less than 50 nm, which to the human eye can appear as though the surface of the reflector has not changed color and thus from a practical perspective the reflector is omnidirectional. In some instances, omnidirectional reflectors disclosed herein can provide a Δλ_{c} of less than 40 nm, in other instances a Δπ_{c} of less than 30 nm, and in still other instances a Δλ_{c} of less than 20 nm, while in still yet other instances a Δλ_{c} of less than 15 nm. Such a shift in Δλ_{c} can be determined by an actual reflectance versus wavelength plot for a reflector, and/or in the alternative, by modeling of the reflector if the materials and layer thicknesses are known.

Another definition or characterization of a reflector's omnidirectional properties can be determined by the shift of a side edge for a given set of angle refection bands. For example, and with reference to FIG. 10, a shift or displacement of an IR-sided edge (ΔS_{IR}) for reflectance from an omnidirectional reflector observed from 0° (S_{IR}(0°)) compared to the IR-sided edge for reflectance by the same reflector observed from 45° (S_{IR}(45°)) provides a measure of the omnidirectional property of the omnidirectional reflector. In addition, using ΔS_{IR} as a measure of omnidirectionality can be preferred to the use of Δλ_{c}, e.g. for reflectors that provide a reflectance band similar to the one shown in FIG. 10 or FIG. 12, i.e. a reflection band that extends into the UV or IR region of EMR. It is appreciated that the shift of the IR-sided edge (ΔS_{IR}) is and/or can be measured at the visible FWHM.

With reference to FIG. 12, a shift or displacement of a UV-sided edge (ΔS_{IR}) for reflectance from an omnidirectional reflector observed from 0° (S_{UV}(0°)) compared to the IR-sided edge for reflectance by the same reflector observed from 45° (S_{UV}(45°)) provides a measure of the omnidirectional property of the omnidirectional reflector. It is appreciated that the shift of the UV-sided edge (ΔS_{UV}) is and/or can be measured at the visible FWHM.

Naturally a zero shift, i.e. no shift at all (ΔSᵢ=0 nm; i=IR, UV), would characterize a perfectly omnidirectional reflector. However, omnidirectional reflectors disclosed herein can provide a ΔS_{L} of less than 50 nm, which to the human eye can appear as though the surface of the reflector has not changed color and thus from a practical perspective the reflector is omnidirectional. In some instances, omnidirectional reflectors disclosed herein can provide a ΔSᵢ of less than 40 nm, in other instances a ΔSᵢ of less than 30 nm, and in still other instances a ΔSᵢ of less than 20 nm, while in still yet other instances a ΔSᵢ of less than 15 nm. Such a shift in ΔSᵢ can be determined by an actual reflectance versus wavelength plot for a reflector, and/or in the alternative, by modeling of the reflector if the materials and layer thicknesses are known.

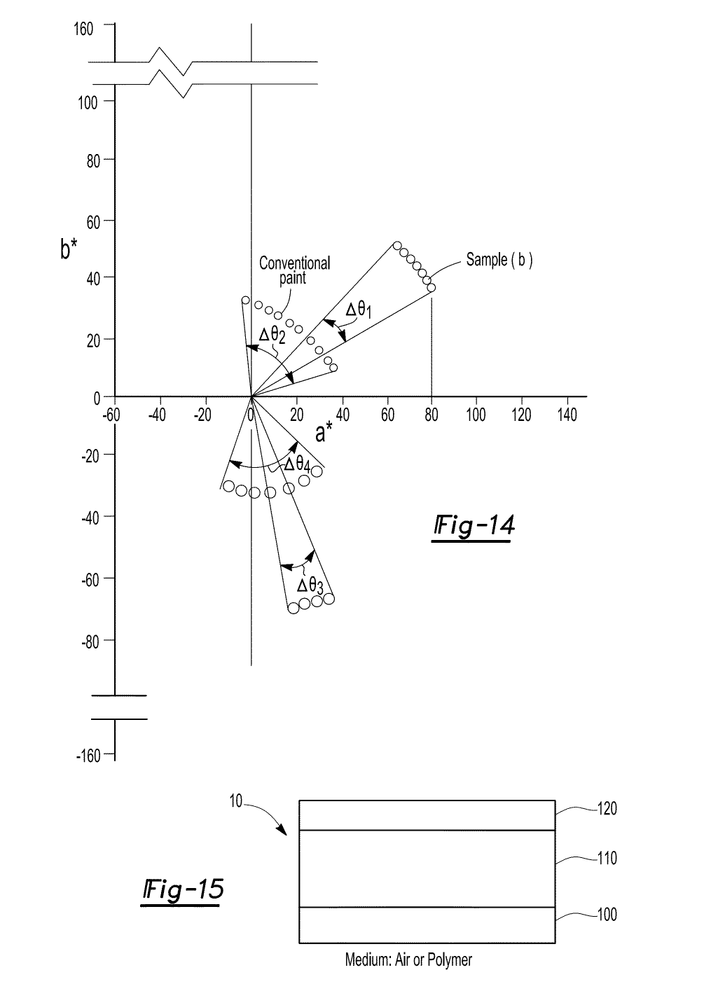

The shift of an omnidirectional reflection can also be measured by a low hue shift. For example, the hue shift of pigments manufactured from multilayer stacks according an embodiment disclosed herein is 30° or less, as shown in FIG. 14 (see e.g., Δθ₁ and Δθ₃), and in some instances the hue shift is 25° or less, preferably less than 20°, more preferably less than 15° and still more preferably less than 10°. In contrast, traditional pigments exhibit hue shift of 45° or more (see e.g. Δθ₂ and Δθ₄). It is appreciated that the hue shift associated with Δθ₁ generally corresponds to a red color, however the low hue shift is relevant for any color reflected by a hybrid omnidirectional structural color pigment disclosed herein. For example, the low hue shift Δθ₃ shown in FIG. 14 generally corresponds to a blue color provided by an exemplary hybrid omnidirectional structural color pigment, whereas the relatively large hue shift exhibited by a traditional blue pigment is illustrated by Δθ₄.

A schematic illustration of an omnidirectional multilayer stack according to another embodiment disclosed herein is shown in FIG. 15 at reference numeral 10. The multilayer stack 10 has a first layer 110 and a second layer 120. An optional reflector layer 100 can be included. Example materials for the reflector layer 100, sometimes referred to as a reflector core layer, can include but is not limited to Al, Ag, Pt, Cr, Cu, Zn, Au, Sn and alloys thereof. As such, the reflector layer 100 can be a metallic reflector layer, however this is not required. In addition, exemplary thicknesses for the core reflector layer range between 30 to 200 nm.

A symmetric pair of layers can be on an opposite side of the reflector layer 100, i.e. the reflector layer 100 can have another first layer oppositely disposed from the first layer 110 such that the reflector layer 100 is sandwiched between a pair of first layers. In addition, another second layer 120 can be oppositely disposed the reflector layer 100 such that a five-layer structure is provided. Therefore, it should be appreciated that the discussion of the multilayer stacks provided herein also includes the possibility of a mirror structure with respect to one or more central layers. As such, FIG. 15 can be illustrative of half of a five-layer multilayer stack.

The first layer 110 can be a high index of refraction (nₕ) dielectric layer that is dry deposited. For the purposes of the instant disclosure, the term high index of refraction material refers to a material that has an index of refraction equal to or greater than 2.0. Also, the term “dry deposited” refers a layer that has been deposited and/or formed using a dry deposition technique known to those skilled in the art such as chemical vapor deposition (CVD) and physical vapor deposition (PVD). Also, the term “dry depositing” refers to depositing a layer using a dry deposition technique known to those skilled in the art.

Example materials for the dry deposited nₕ dielectric layer 110 include, but are not limited to CeO₂, Nb₂O₅, SiN, SnO₂, SnS, TiO₂, ZnO, ZnS and ZrO₂. In addition, the dry deposited nₕ dielectric layer(s) can have a thickness between 0.1 QW and 4.0 QW for a desired control wavelength, the desired control wavelength being a center wavelength for a desired color reflection band. It is appreciated that the term “QW” or “QW thickness” refers to a thickness that is one-quarter of the desired control wavelength, i.e. QW=λ_{cw}/4 where λ_{cw} is the desired control wavelength.

The second layer 120 can be a dry deposited absorbing layer. Exemplary absorbing layer materials include but are not limited to Cr, Cu, Au, Sn, alloys thereof, amorphous Si and Fe₂O₃, and the thickness of the second layer 120 is preferably between 2 and 30 nm.

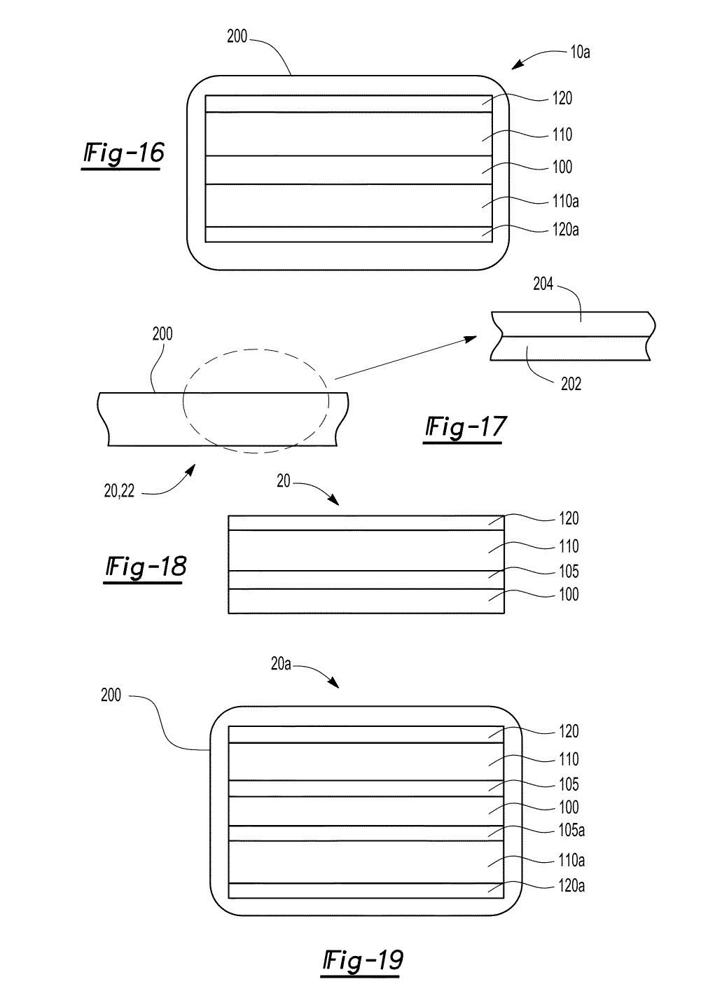

FIG. 16 illustrates a five-layer design pigment 10a with symmetric layers, including an outer protective layer 200, extending across the reflector core layer 100. The pigment 10a has oppositely disposed dry deposited nₕ dielectric layer 110a and dry deposited absorbing layer 120a. The outer protective layer 200 can be a wet deposited protective layer and/or a nₕ oxide layer. It is appreciated that the term “wet deposited” refers to a layer that has been deposited and/or formed using a wet chemistry technique known to those skilled in the art such as sol gel processing, layer-by-layer processing, spin coating and the like. Exemplary examples of wet deposited layer materials include CeO₂, Nb₂O₅, SnO₂, TiO₂, ZnO and ZrO₂ and a thickness of such a layer can be within a range of 5-200 nm.

A non-exhaustive list of materials that the dry deposited nₕ dielectric and/or wet deposited nₕ outer proactive layers can be made from are shown is shown in Table 2 below.

TABLE 2

| Refractive Index Materials | | Refractive Index Materials | |
|---|---|---|---|
| (visible region) | | (visible region) | |
| | Refractive | | Refractive |
| Material | Index | Material | Index |
| Germanium (Ge) | 4.0-5.0 | Chromium (Cr) | 3.0 |
| Tellurium (Te) | 4.6 | Tin Sulfide (SnS) | 2.6 |
| Gallium Antimonite (GaSb) | 4.5-5.0 | Low Porous Si | 2.56 |
| Indium Arsenide (InAs) | 4.0 | Chalcogenide glass | 2.6 |
| Silicon (Si) | 3.7 | Cerium Oxide (CeO₂) | 2.53 |
| Indium Phosphate (InP) | 3.5 | Tungsten (W) | 2.5 |
| Gallium Arsenate (GaAs) | 3.53 | Gallium Nitride (GaN) | 2.5 |
| Gallium Phosphate (GaP) | 3.31 | Manganese (Mn) | 2.5 |
| Vanadium (V) | 3 | Niobium Oxide (Nb₂O₃) | 2.4 |
| Arsenic Selenide (As₂Se₃) | 2.8 | Zinc Telluride (ZnTe) | 3.0 |
| CuAlSe₂ | 2.75 | Chalcogenide glass + Ag | 3.0 |
| Zinc Selenide (ZnSe) | 2.5-2.6 | Zinc Sulfide (ZnS) | 2.5-3.0 |
| Titanium Dioxide (TiO₂) - | 2.36 | Titanium Dioxide (TiO₂) - | 2.43 |
| solgel | | vacuum deposited | |
| SnO2 | 2.0 | Hafnium Oxide (HfO₂) | 2.0 |
| Zinc Sulfide (ZnS) | 2.3 + | Niobium Oxide (Nb₂O₅) | 2.1 |
| | i(0.015) | | |
| Titanium Nitride (TiN) | 1.5 + i(2.0) | Aluminum (Al) | 2.0 + i(15) |
| Chromium (Cr) | 2.5 + i(2.5) | Silicon Nitride (SiN) | 2.1 |
| Niobium Pentoxide(Nb2O5) | 2.4 | Zirconium Oxide (ZrO2) | 2.36 |
| Hafnium Oxide (HfO2) | 1.9-2.0 | | |

In some instances, the outer protective layer 200 can be made from two wet deposited layers as illustrated in FIG. 17. For example, a wet deposited layer 202 can be a first nₕ oxide and a wet deposited layer 204 can be a second nₕ oxide. In addition, a single outer protective layer 200, the layer 202 and/or the layer 204 can be a mixed nₕ oxide layer that contains one or more nₕ oxides.

It is appreciated that the five-layer design shown in FIG. 16 has an absorber layer 120 and 120a directly adjacent to or underneath the outer protective layer 200. Stated differently, a five-layer pigment produced by dry deposition, and before it has been coated with an outer protective layer, has an outer absorbing layer and not an outer dielectric layer. It is also appreciated that the outer protective layer can serve not only as a protective layer, but also as a color enhancing layer. For example and for illustrative purposes only, the outer protective layer 200 can serve only as a protective coating and have no effect on the color exhibited by the pigment 10a. As such, the entire color of the pigment 10a is provided by the reflector core layer 100, the dry deposited nₕ dielectric layer 110, 110a, and the absorbing layer 120, 120a. In the alternative, the outer protective layer 200 can provide some color effect to the pigment 10a such as an increase in chroma of the pigment, a slight shift in the “color” exhibited to the human eye by the pigment, a slight increase in omnidirectionality of the pigment (i.e. a reduce of the color shift), a slight decrease in omnidirectionality of the pigment, and the like.

Turning now to FIG. 18, another embodiment of an inventive multilayer stack is shown at reference numeral 20. The multilayer stack 20 is similar to the multilayer stack 10 except for an additional absorbing layer 105 extending between the reflector core layer 100 and the dry deposited nₙ dielectric layer 110. Also similar to the pigment 10a shown in FIG. 16, a pigment 20a is shown in FIG. 19 in which symmetric layers 105a, 110a and 120a extend across the reflector core layer 100 and are oppositely disposed from layers 105, 110 and 120, respectively. The pigment 20a also has the wet deposited nₕ outer protective oxide layer 200.

Methods for producing the multilayer stacks disclosed herein can be any method or process known to those skilled in the art or one or methods not yet known to those skilled in the art. Typical known methods include wet methods such as sol gel processing, layer-by-layer processing, spin coating and the like. Other known dry methods include chemical vapor deposition processing and physical vapor deposition processing such as sputtering, electron beam deposition and the like.

The multilayer stacks disclosed herein can be used for most any color application such as pigments for paints, thin films applied to surfaces and the like. In addition, the pigments illustrated in FIGS. 16 and 18 exhibit omnidirectional structural color characteristics as shown in FIGS. 10-14.

In order to better teach the invention but not limit its scope in any way, examples of weather resistant omnidirectional structural color pigments and a process protocols to produce such pigments is discussed below.

Protocol 1—5-Layer Pigments Coated with a ZrO₂ Layer

Two grams of 5-layer pigments were suspended in 30 ml of ethanol in a 100 ml round bottom flask and stirred at 500 rpm at room temperature. A solution of 2.75 ml of zirconium butoxide (80% in 1-Butanol) dissolved in 10 ml of ethanol was titrated in at constant rate in 1 hour. At the same time, 1 ml of DI water diluted in 3 ml of ethanol was metered in. After the titration, the suspension was stirred for another 15 minutes. The mixture was filtered, washed with ethanol and then isopropanol, and dried at 100° C. for 24 hours, or in the alternative further annealed at 200° C. for 24 h, with the end results being a 5-layer pigment with a structure as illustrated in FIG. 16. Further annealing at higher temperature can be applied if needed.

Protocol 2—5-Layer Pigments Coated with a TiO₂ Layer

Two grams of 5-layer pigments were suspended in 30 ml of IPA in a 100 ml round bottom flask and stirred at 40° C. Then, a solution of 2.5 ml of titanium ethoxide (97%) dissolved in 20 ml of IPA was titrated in at constant rate in 2.5 hours. At the same time, 2.5 ml of DI water diluted in 4 ml of IPA was metered in. After the titration, the suspension was stirred for another 30 minutes. The mixture was then allowed to cool to room temperature, filtered, washed with IPA and dried at 100° C. for 24 hours, or in the alternative further annealed at 200° C. for 24 h, with the end results being a 5-layer pigment with a structure as illustrated in FIG. 16. Further annealing at higher temperature can be applied if needed.

A summary of coatings, the process used to produce a coating, coating thickness, coating thickness uniformity and photocatalytic activity is shown in Table 3 below.

TABLE 3

| | | | | Coating | Thickness | | Photocatalytic |
|---|---|---|---|---|---|---|---|
| Sample | Core* | Layer | Material | Protocol | (nm) | Uniformity | Activity** |
| 1 | P5 | 1^{st} | CeO₂ | *** | 20 | G | 70% |
| 2 | P5 | 1^{st} | ZrO₂ | 1 | 80 | G | 29% |
| 3 | P5 | 1^{st} | TiO₂ | 2 | 80 | G | 36% |
| 4 | P5 | 1^{st} | TiO₂ | 2 | 80 | G | 27% |
| | | 2^{nd} | ZrO₂—Al₂O₃ | *** | 15 | G | |

*P5 = 5-layer pigment
**compared to non-coated 5-layer pigment
*** proprietary coating protocol

Given the above, Table 4 provides a listing of various oxide layers, substrates that can be coated and ranges of coating thickness included within the instant teachings.

TABLE 4

| | | Range of |
|---|---|---|
| Oxide Layer | Substrate | Coating Thickness (nm) |
| SiO₂ | Mica, P5, metal, oxides | 10-160 |
| TiO₂ | Mica, P5, metal, oxides | 20-100 |
| ZrO₂ | Mica, P5, metal, oxides | 20-100 |
| Al₂O₃ | Mica, P5, metal, oxides | 5-30 |
| CeO₂ | Mica, P5, Oxides | ~5-40 |
| SiO₂—Al₂O₃ | Mica, P5, oxides | 20-100 |
| ZrO₂—Al₂O₃ | Mica, P5, metal, oxides | 10-50 |

In addition to the above, the omnidirectional structural color pigments with a protective coating can be subjected to an organo-silane surface treatment. For example, one illustrative organo-silane protocol treatment suspended 0.5 g of pigments coated with one or more of the protection layers discussed above in a 10 ml of EtOH/water (4:1) solution having pH about 5.0 (adjusted by diluted acetic acid solution) in a 100 ml round bottom flask. The slurry was sonicated for 20 seconds then stirred for 15 minutes at 500 rpm. Next, 0.1-0.5 vol % of an organo-silane agent was added to the slurry and the solution was stirred at 500 rpm for another 2 hours. The slurry was then centrifuged or filter using DI water and the remaining pigments were re-dispersed in 10 ml of a EtOH/water (4:1) solution. The pigment-EtOH/water slurry was heated to 65° C. with reflux occurring and stirred at 500 rpm for 30 minutes. The slurry was then centrifuged or filtered using DI water and then IPA to produce a cake of pigment particles. Finally, the cake was dried at 100° C. for 12 hours. Further annealing at higher temperature can be applied if needed.

The organo-silane protocol can use any organo-silane coupling agent known to those skilled in the art, illustratively including N-(2-aminoethyl)-3-aminopropyltrimethoxysilane (APTMS), N-[3-(Trimethoxysilyl)propyl]ethylenedi amine 3-methacryloxypropyltrimethoxy-silane (MAPTMS), N-[2(vinylbenzylamino)-ethyl]-3-aminopropyltrimethoxysilane, 3-glycidoxypropyltrimethoxysilane and the like.

The above examples and embodiments are for illustrative purposes only and changes, modifications, and the like will be apparent to those skilled in the art and yet still fall within the scope of the invention. As such, the scope of the invention is defined by the claims and all equivalents thereof.

We claim:

1. A hybrid omnidirectional structural color pigment comprising:
a multilayer stack having:
a reflective core layer;
a dry deposited high index of refraction (nₕ) dielectric layer extending across said reflective core layer;
a dry deposited absorber layer extending across said nₕ dielectric layer; and
a wet deposited nₕ outer oxide layer extending across said absorber layer;
said multilayer stack having a reflection band with a predetermined full width at half maximum (FWHM) of less than 300 nm and a predetermined color hue shift of less than 30° when said multilayer stack is exposed to broadband electromagnetic radiation and viewed from angles between 0 and 45° relative to normal of an outside surface of said multilayer stack.

2. The hybrid omnidirectional structural color pigment of claim 1, wherein said reflective core layer is a metallic core reflector layer having a thickness between 30-200 nm and is a metallic material selected from at least one of the group consisting of Al, Ag, Pt, Cr, Cu, Zn, Au, Sn and alloys thereof.

3. The hybrid omnidirectional structural color pigment of claim 2, wherein said dry deposited nₕ dielectric layer is a dielectric material selected from at least one of the group consisting of CeO₂, Nb₂O₅, SiN, SnO₂, SnS, TiO₂, ZnO, ZnS and ZrO₂.

4. The hybrid omnidirectional structural color pigment of claim 3, wherein said dry deposited nₕ dielectric layer has a thickness between 0.1 QW-4.0 QW for a desired control wavelength.

5. The hybrid omnidirectional structural color pigment of claim 4, wherein said dry deposited absorber layer is an absorber material selected from at least one of the group consisting of Cr, Cu, Au, Sn, alloys thereof, amorphous Si and Fe₂O₃.

6. The hybrid omnidirectional structural color pigment of claim 5, wherein said dry deposited absorber layer has a thickness between 2-30 nm.

7. The hybrid omnidirectional structural color pigment of claim 6, wherein said wet deposited nₕ outer oxide layer is an oxide selected from at least one of the group consisting of CeO₂, Nb₂O₅, SnO₂, TiO₂, ZnO and ZrO₂.

8. The hybrid omnidirectional structural color pigment of claim 7, wherein said wet deposited nₕ outer oxide layer has a thickness between 5-200 nm.

9. The hybrid omnidirectional structural color pigment of claim 8, wherein said dry deposited nₕ dielectric layer is a pair of nₕ dielectric layers with said reflective core layer extending therebetween, said dry deposited absorber layer is a pair of dry deposited absorber layers with said pair of nₕ dielectric layers extending therebetween and said wet deposited nₕ outer oxide layer extends across outer surfaces of said pair of dry deposited absorber layers.

10. The hybrid omnidirectional structural color pigment of claim 9, wherein said multilayer stack has a thickness of less than 2.0 μm.

11. The hybrid omnidirectional structural color pigment of claim 9, wherein said multilayer stack has a thickness of less than 1.5 μm.

12. The hybrid omnidirectional structural color pigment of claim 11, wherein said multilayer stack has less than 10 layers.

13. The hybrid omnidirectional structural color pigment of claim 12, wherein said multilayer stack has less than 8 layers.

14. A process for making an onidirectional structural color pigment, the process comprising:
manufacturing a multilayer stack by:
providing a reflective core layer;
dry depositing a high index of refraction (nₕ) dielectric layer that extends across the reflective core layer;
dry depositing an absorber layer that extends across the nₕ dielectric layer; and
wet depositing an outer nₕ oxide layer that extends across the absorber layer;
the multilayer stack having a reflection band with a predetermined full width at half maximum (FWHM) of less than 300 nm and a predetermined color hue shift of less than 30° when the multilayer stack is exposed to broadband electromagnetic radiation and viewed from angles between 0 and 45° relative to normal of an outside surface of the multilayer stack.

15. The process of claim 14, wherein the reflective core layer is a metallic core reflector layer having a thickness between 30-200 nm made from a metallic material selected from at least one of the group consisting of Al, Ag, Pt, Cr, Cu, Zn, Au, Sn and alloys thereof; and
the dry deposited nₕ dielectric layer has a thickness between 0.1 QW-4.0 QW for a desired control wavelength and is made from a dielectric material selected from at least one of the group consisting of CeO₂, Nb₂O₅, SiN, SnO₂, SnS, TiO₂, ZnO, ZnS and ZrO₂.

16. The process of claim 15, wherein the dry deposited absorber layer has a thickness between 2-30 nm and is made from an absorber material selected from at least one of the group consisting of Cr, Cu, Au, Sn, alloys thereof, amorphous Si and Fe₂O₃.

17. The process of claim 16, wherein the wet deposited nₕ outer oxide layer has a thickness between 5-200 nm and is an oxide selected from at least one of the group consisting of CeO₂, Nb₂O₅, SnO₂, TiO₂, ZnO and ZrO₂.

18. The process of claim 17, wherein the multilayer stack has less than 10 layers.

19. The process of claim 17, wherein the multilayer stack has less than 8 layers.

20. The process of claim 17, wherein the multilayer stack has an overall thickness of less than 2.0 μm.
